(19) United States
(12) Patent Application Publication
(10) Pub. No.: US 2026/0180679 A1
(43) Pub. Date: Jun. 25, 2026

(54) EVENT DETECTION BASED ON COORDINATED OPTICAL NETWORK AND WIRELESS NETWORK SENSING

(71) Applicant: Verizon Patent and Licensing Inc., Basking Ridge, NJ (US)

(72) Inventors: Jun Shan Wey, Sammamish, WA (US); Tiejun J. Xia, Richardson, TX (US); Mark T. Watts, Newport, RI (US); Glenn A. Wellbrock, Wichita, KS (US)

(21) Appl. No.: 18/999,362

(22) Filed: Dec. 23, 2024

(51) Int. Cl. H04B 10/07; H04B 10/25

(52) U.S. Cl. CPC H04B 10/07; H04B 10/25

(57) ABSTRACT

A device obtains an indication of an object or event detected in a vicinity of a fiber optic network by a Radio Access Network (RAN) of a mobile network using wireless sensing. The device acquires, based on the RAN-detected at least one object or event, one or more of strain, temperature, or vibration data related to the fiber optic network. The device performs a risk assessment related to the fiber optic network based on the RAN-detected object or event and the acquired strain, temperature, and/or vibration data, and communicates results of the risk assessment to an optical fiber network management system, a field technician, or a field engineer.

### BACKGROUND

Distributed Fiber-Optic Sensing (DFOS) is a technology implemented in optical fiber networks to perform remote sensing of various environmental parameters that have an effect on the optical fiber networks. An optical fiber network implementing DFOS may act as a distributed sensor to acquire strain, temperature, and/or vibration data via Brillouin, Raman, or Rayleigh scattering in the optical fiber network. DFOS includes distributed strain sensing (DSS), distributed temperature sensing (DTS), and distributed acoustic sensing (DAS) to acquire the strain, temperature, and vibration data. DFOS has been used to displace conventional electromechanical-based sensors in, for example, mining, environmental, civil, and geo-energy fields. In mining or geo-energy, for example, DFOS has been used to visualize underground deformations, underground temperatures, and seismic activity over substantial distances.

### BRIEF DESCRIPTION OF THE DRAWINGS

FIG. 1 depicts an example network environment in which optical network sensing and wireless network sensing may be coordinated together to detect objects and/or the occurrence of events in the vicinity of a deployed optical fiber network;

FIG. 2 depicts an example of a mobile network and various interconnections with other nodes, devices, or networks;

FIG. 3 is a diagram that depicts example components of a device, as referred to herein;

FIG. 4 depicts a simplified example of the implementation of wireless sensing, by a Radio Unit (RU) of a mobile network, to detect an object;

FIGS. 5A and 5B illustrate an overview of the coordination of wireless sensing involving a Radio Access Network (RAN) and Distributed Fiber Optic Sensing (DFOS) involving an optical fiber network;

FIG. 6 depicts an example of components of a RU of a RAN of a mobile network that may be used in performing wireless sensing;

FIG. 7 depicts an example of components of DFOS equipment; and

FIGS. 8A and 8B are flow diagrams of an example process for coordinating wireless sensing performed by a RAN of mobile network and DFOS performed by DFOS equipment to assess risks related to an optical fiber network.

### DETAILED DESCRIPTION

The following detailed description refers to the accompanying drawings. The same reference numbers in different drawings may identify the same or similar elements. The following detailed description does not limit the invention.

Wireless sensing has been proposed to be incorporated, in Next Generation networks, to enable the Radio Access Network (RAN) to obtain information about characteristics of the environment and/or objects within the environment. Such information may include, for example, a shape, size, orientation, speed, or location of an object, distances between objects, or a relative motion between objects within a coverage area of the RAN. Wireless sensing capability in Next Generation RANs has been termed as “Integrated Sensing and Communication” (ISAC). ISAC uses reflections of, or the scattering of, wireless sensing signals transmitted from Radio Units (RUs) of the RAN, and various different techniques (e.g., Time Difference of Arrival (TDoA), Angle of Arrival (AoA), Angle of Departure (AoD)), to determine characteristics of the environment or objects within the environment.

Example embodiments described herein coordinate wireless sensing performed by the RAN of a mobile network, such as Next Generation mobile networks, with DFOS performed by DFOS equipment connected to, or within, an optical fiber network. The wireless sensing performed by the RAN may be used to identify potential objects and/or events located within a certain proximity to components of the optical fiber network, and the RAN may then send an alert to the DFOS equipment, or to devices carried by field technicians/engineers who control the DFOS equipment, to initiate performance of DFOS by the DFOS equipment. The potential objects and/or events to be detected by the mobile network RAN may include, for example, construction equipment (e.g., digging machines), aerial vehicles near aerial optical fibers, traffic accidents within proximity to optical fiber network components, or natural events or disasters that may impact optical fiber network components. DFOS may acquire strain, temperature, and/or vibration data by detecting Brillouin, Raman, and/or Rayleigh scattering over the optical fibers of the optical fiber network. The DFOS equipment, or the RAN, may then use the resulting DFOS strain, temperature, and/or vibration data, in conjunction with the RAN identified potential objects and/or events, to perform a risk assessment related to threats to, or impacts upon, the optical fiber network. The risk assessment may subsequently be used to initiate performance testing and/or repairs of the optical fiber network, or to alter the operation of the optical fiber network, such as, for example, re-routing traffic around certain components or areas of the optical fiber network.

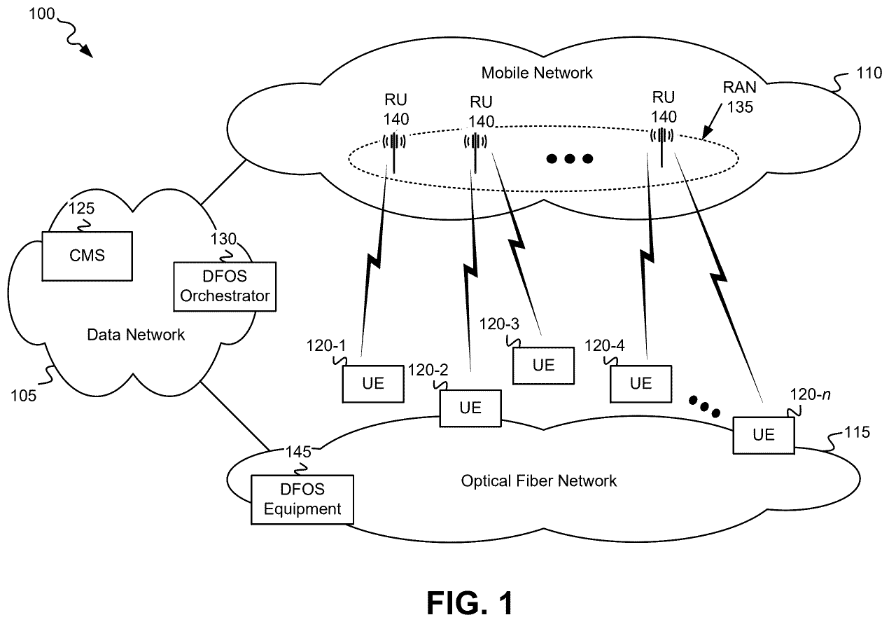

FIG. 1 depicts an example network environment 100 in which wireless network sensing and optical network sensing may be coordinated together to detect certain objects and/or the occurrence of certain events in the vicinity of a deployed optical fiber network. As shown, network environment 100 may include a data network 105, a mobile network 110, an optical fiber network 115, and multiple user equipment devices (UEs) 120-1 through 120-n.

Data network 105 may include one or more interconnected networks, such as local area networks (LANs), wide area networks (WANs), metropolitan area networks (MANs), Public Switched Telephone Networks (PSTNs), Multi-Access Edge Computing networks (MECs), and/or the Internet. Data network 105 may, for example, connect with User Plane Functions (UPFs—not shown) of mobile network 105. As further shown, data network 105 may include, or be interconnected with a Control and Management System (CMS) 125 and a DFOS Orchestrator 130.

CMS 125 may include one or more network devices that maintain data related to the configuration and operation of optical fiber network 115 and/or mobile network 110. CMS 125 may additionally initiate testing and/or repairs of optical fiber network 115 and/or mobile network 110, or control/alter the operation of optical fiber network 115 and/or mobile network 110. DFOS Orchestrator 130 may include one or more devices that determine and generate potential threat object and/or event lists to send to RUs 140 of RAN 135 for use during wireless sensing.

Mobile network 110 (also referred to herein as “wireless network 110”) may include any type of a Public Land Mobile Network (PLMN). In some implementations, mobile network 110 may include any type of a Next Generation mobile network that may include evolved network components (e.g., future generation components) relative to a Long-Term Evolution (LTE) network, such as a Fourth Generation (4G) or 4.5G LTE mobile network. For example, mobile network 110 may include a Fifth Generation (5G) mobile network. Mobile network 110 may alternatively include another type of Next Generation network, such as, for example, a Sixth Generation (6G) mobile network, a hybrid network environment, etc.

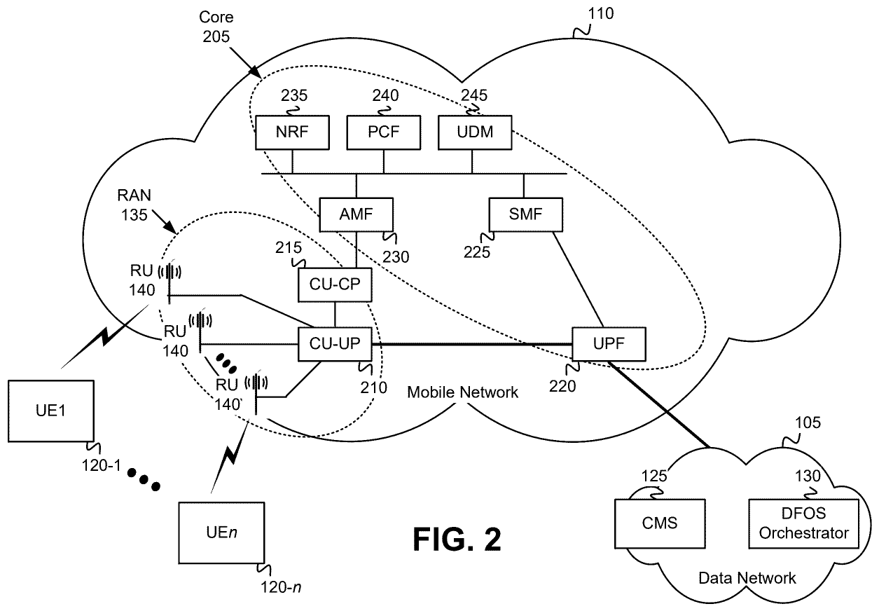

Mobile network 1105 may include, among other nodes, functions, devices, or sub-networks, a Radio Access Network (RAN) 135. Additional nodes, functions, devices, and sub-networks of mobile network 110 are described below with respect to FIG. 2. RAN 135 includes various types of radio access equipment that enable wireless communication (e.g., Radio Frequency (RF) communication) with UEs 120-1 through 120-n. The radio access equipment of RAN 135 may include, for example, multiple Radio Units (RUs) 140, multiple Distributed Units (DUs—not shown), and other components described further below with respect to FIG. 2.

Optical fiber network 115 may include a network of interconnected optical fibers. Optical fiber network 115 may additionally include, among other components, central offices (COs), optical transmitters, optical amplifiers, optical receivers, optical switches and/or routers, wavelength division multiplexers/demultiplexers, optical add/drop multiplexers, and/or DFOS equipment 145. The optical fibers, and other components, of optical fiber network 115 may be buried underground or may be located in above-ground deployments (e.g., aerial optical fibers that traverse an area between supporting poles, towers, or other vertical structures). COs, for example, may have above-ground deployments that are located in close proximity to one or more underground or aerial optical fibers.

DFOS equipment 145 may include one or more systems or devices that may perform DFOS upon optical fiber network 115 based on, for example, alerts received from RAN 135 of mobile network 110. In some implementations, DFOS equipment 145 may additionally perform risk assessments, as described further herein, related to optical fiber network 115 using the results of the DFOS and the results of the wireless sensing performed by RAN 135. DFOS equipment 145 may be a stand-alone device or system, or a device or system that is a component of a larger device or system.

UEs 120-1 through 120-n (referred to herein as “UE 120” or “UEs 120”) may each include any type of electronic device having a wireless communication capability. Network environment 100 may include any number of UEs 120, with several being shown (e.g., n>>2). UE 120 may include, for example, a laptop, desktop, or tablet computer; a cellular phone (e.g., a “smart” phone); a Voice over Internet Protocol (VOIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (not shown) may carry, use, administer, and/or operate each UE 120.

The configuration of components of the network environment 100 of FIG. 1 is for illustrative purposes. Other configurations, having a different arrangement than depicted in FIG. 1, may be implemented. Network environment 100 may also include additional, fewer, and/or different components, networks, or sub-networks than shown in FIG. 1.

FIG. 2 depicts an example of mobile network 110 and its various interconnections with other nodes, devices, or networks. As shown, mobile network 110 may connect with UEs 120-1 through 120-n and data network 105. In the example shown, mobile network 110 may include sub-networks, such as RAN 135 and a core network 205. The radio access equipment of RAN 135 may include multiple RUs 140, multiple DUs (not shown), at least one Control Unit-User Plane function (CU-UP) 210 and at least one Control Unit-Control Plane (CU-CP) function 215. Additionally, or alternatively, RAN 135 may include non-split or integrated RAN devices, such as a Next Generation NodeB (gNB) or Evolved NodeB (eNB). Only a single one of CU-UP 210 and CU-CP 215 is shown in FIG. 2, however, RAN 135 may include multiple CU-UPs 210 and CU-CPs 215. In some implementations, each CU-UP 210 and CU-CP 215 may be associated with one or more clusters of cells within RAN 135. For example, a particular CU-CP 215 may control and manage the operation of DUs and RUs 140 residing within one or more clusters of cells, and a corresponding CU-UP 210 may manage and handle user plane traffic that originates from, or is destined to, the DUs and RUs residing within the one or more clusters of cells. The CU-UP 210, among other functions, routes outgoing traffic (e.g., from a UE 120) to a UPF 220 and routes incoming traffic to a DU and RU 140 that serves the traffic's destination UE 120.

Each DU includes a logical node that hosts functions associated with the Radio Link Control (RLC) layer, the Medium Access Control (MAC) layer, and the physical layer (PHY). Each DU further performs centralized processing and coordination of one or more RUs 140, handles tasks such as scheduling and overall control of the radio resources, and interfaces with core network functions (NFs) to establish and manage connections with UEs 120 and to facilitate communication between different cells.

RUs 140 may be located at certain geographic positions within mobile network 110, and operate as radio function units that transmit and receive wireless signals (e.g., Radio Frequency (RF) signals) to/from UEs 120. Each of the RUs 140 may include at least one antenna array, transceiver circuitry, and other hardware and software components for enabling the RU 140 to receive data via wireless signals from UEs 120, and to transmit wireless signals to UEs 120. Each RU 140 may connect to a respective DU (not shown) which, in turn, connects to a CU-UP 210 and a CU-CP 215.

CU-UP 210 may interconnect with one or more DUs via fronthaul links or a fronthaul network and may include a logical node that hosts user plane functions, such as, for example, data routing and transport functions. CU-CP 215 includes a logical node that hosts Radio Resource Control (RRC), and other control plane, functions (e.g., Service Data Adaptation Protocol (SDAP), Packet Data Convergence Protocol (PDCP)) for the CU-UP 210 and for the DUs and RUs 140 that it controls. RAN 135 may additionally include other nodes, functions, and/or components not shown in FIG. 2.

Core network 205 includes devices or nodes that host and execute NFs that operate the mobile network 110 including, among other NFs, mobile network access management, session management, and policy control NFs. In the example mobile network 110 of FIG. 2, core network 205 is shown as including 5G NFs, such as a UPF 220, a Session Management Function (SMF) 225, an Access and Mobility Management Function (AMF) 230, a Network Repository Function (NRF) 235, a Policy Control Function (PCF) 240, and a Unified Data Management (UDM) function 245. Each of UPF 220, SMF 225, AMF 230, NRF 235, PCF 240, and UDM 245 may be implemented as a Virtual Network Function (VNF) or a Cloud-Native Network Function (CNF) (e.g., at a data center(s)) or as a Physical Network Function (PNF) within mobile network 110.

UPF 220 may act as a router and a gateway between mobile network 110 and data network 105 and may forward session data between data network 105 and RAN 135. Though only a single UPF 220 is shown in FIG. 2, mobile network 110 may include multiple UPFs 220 at various locations in mobile network 110. SMF 225 performs session management and selects and controls UPFs 220 for data transfer. AMF 230 performs mobility management for the UEs 120.

NRF 235 operates as a centralized repository of information regarding NFs in mobile network 110. NRF 235 enables NFs (e.g., UPF 220, SMF 225, AMF 230, PCF 240, UDM 245) to register and discover each other via an Application Programming interface (API). NRF 235 maintains an updated repository of information about the NFs available in mobile network 110, along with information about the services provided by each of the NFs. NRF 235 further enables the NFs to obtain updated status information of other NFs in mobile network 110. NRF 235 may, for example, maintain profiles of available NF instances and their supported services, allow NF instances to discover other NF instances in mobile network 105, and allow NF instances to track the status of other NF instances.

PCF 240 may provide policy rules for control plane functions (e.g., for network slicing, roaming, and/or mobility management) and may access user subscription information for policy decisions. UDM 245 manages data for user access authorization, user registration, and data network profiles. UDM 245 may include, or operate in conjunction with, a User Data Repository (UDR-not shown) which stores user data, such as user/customer/subscriber profile information, user/customer/subscriber authentication information, user/customer-subscribed network slice information, and encryption keys.

The configuration of network components of the example mobile network 110 of FIG. 2 is for illustrative purposes. Other configurations may be implemented. Therefore, mobile network 110 may include additional, fewer, and/or different components that may be configured in a different arrangement than that depicted in FIG. 2.

Mobile network 110 is shown in the example of FIG. 2 as including components associated with a 5G mobile network. In other implementations, however, different types of mobile networks or different mobile network components may alternatively, or additionally, be used, such as 4G mobile networks and/or hybrid 4G/5G mobile networks. Core network 205 may include other NFs not shown in FIG. 2. Additionally, though only a single instance of each of the core network NFs (e.g., UPF 220, SMF 225, AMF 230, NRF 235, PCF 240, UDM 245) is shown in FIG. 2, mobile network 110 may include multiple instances of each of the NFs. When implemented as VNFs or CNFs, each of the NFs described above may be installed in, and executed by, a network device residing in mobile network 110, or in another network (e.g., in an edge or a far edge network, not shown). A single network device may host and execute one or more of the NFs described above, and mobile network 105 may include at least one network device, or may have multiple (e.g., numerous) network devices that each host and execute one or more of the NFs described above.

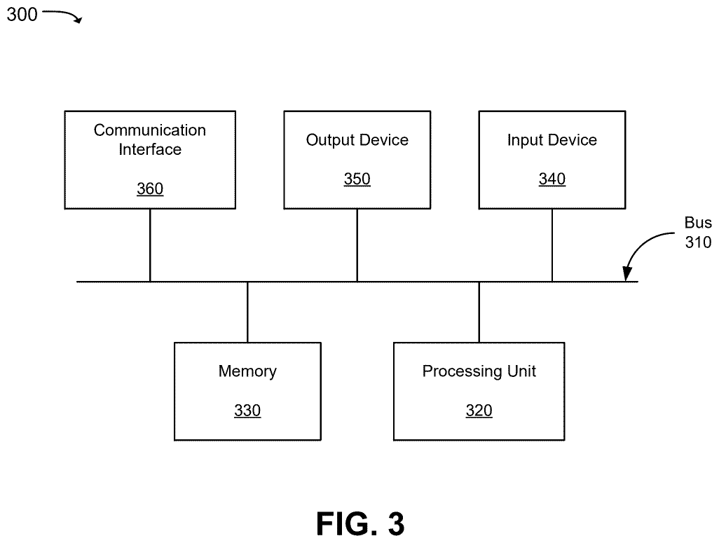

FIG. 3 is a diagram that depicts example components of a device 300 (referred to herein as a “network device,” a “device,” or a “system”). UEs 120, the RUs 140, DUs, CU-UP 210, CU-CP 215, CMS 125, and DFOS orchestrator 130 may each include components that are the same as, or similar to, those of device 300 shown in FIG. 3. Furthermore, each of the NFs in mobile network 110 (e.g., UPF 220, SMF 225 AMF 230, NRF 235, PCF 240, and/or UDM 245) may be implemented by a device that includes components that are the same as, or similar to, those of network device 300. Some of the NFs of mobile network 105 may be implemented by a same device 300 within mobile network 110, while others of the functions may be implemented by one or more separate devices 300 within mobile network 110. DFOS equipment 145 may be implemented by a device or system that includes components that are the same as, or similar to, those of network device 300.

Device 300 may include a bus 310, a processing unit 320, a memory 330, an input device 340, an output device 350, and a communication interface 360. Bus 310 may include a path that permits communication among the components of device 300. Processing unit 320 may include one or more processors or microprocessors which may interpret and execute instructions, or processing logic. Memory 330 may include one or more memory devices for storing data and instructions. Memory 330 may include a random access memory (RAM) or another type of dynamic storage device that may store information and instructions for execution by processing unit 320, a Read Only Memory (ROM) device or another type of static storage device that may store static information and instructions for use by processing unit 320, and/or a magnetic, optical, or flash memory recording and storage medium. The memory devices of memory 330 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 330 for execution by processing unit 320.

Input device 340 may include one or more mechanisms that permit an operator to input information into device 300, such as, for example, a keypad or a keyboard, a display with a touch sensitive panel, voice recognition and/or biometric mechanisms, etc. Output device 350 may include one or more mechanisms that output information to the operator, including a display, a speaker, etc. Input device 340 and output device 350 may, in some implementations, be implemented as a user interface (UI) that displays UI information and which receives user input via the UI. Communication interface 360 may include a transceiver(s) that enables device 300 to communicate with other devices and/or systems. For example, communication interface 360 may include one or more wired and/or wireless transceivers for communicating via mobile network 110 and/or data network 105. In the case of RUs 140 of RAN 135, communication interface 360 may further include one or more antennas or antenna arrays for producing radio frequency (RF) cells or cell sectors.

The configuration of components of network device 300 illustrated in FIG. 3 is for illustrative purposes. Other configurations may be implemented. Therefore, network device 300 may include additional, fewer and/or different components, that may be arranged in a different configuration, than depicted in FIG. 3.

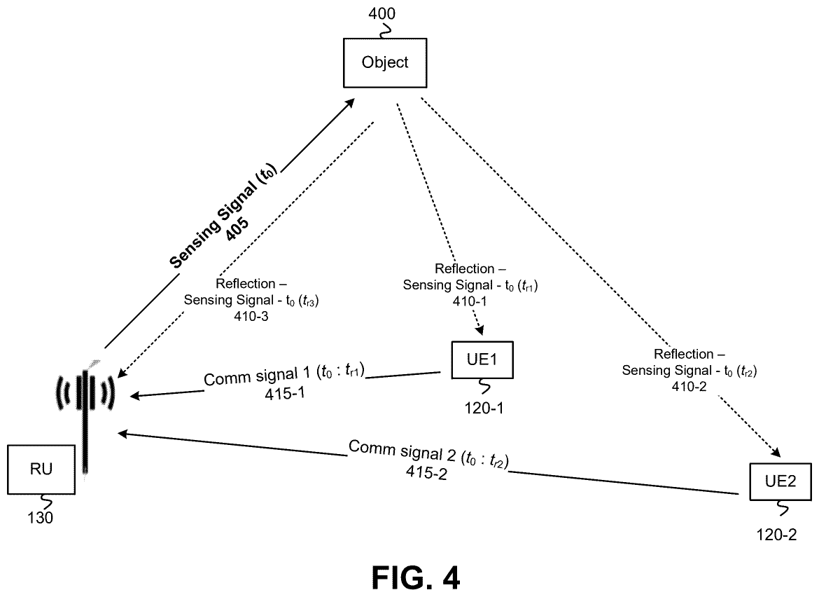

FIG. 4 depicts a simplified example of the implementation of wireless sensing, by an RU 140 of mobile network 110, to detect an object 400. Implementation of wireless sensing (e.g., ISAC), as shown in FIG. 4, involves multiple UEs 120 (UEs 120-1 and 120-2 shown as an example) receiving sensing signals transmitted from RU 140 and reflected from, or backscattered by, the object 400. Implementation of the wireless sensing may require that RU 140, and UEs 120 receiving sensing signals from RU 140, each accurately maintain a time clock that is synchronized with a central time clock (e.g., maintained by the mobile network 110).

In the simplified example of FIG. 4, RU 140 may transmit a wireless sensing signal 405, at time instant to, in a particular direction that coincides with an object 400 that resides in the vicinity of RU 140. A first reflection 410-1 of the sensing signal, originally transmitted at time t₀ and reflected off of object 400, reaches a location of UE 120-1 and is received at a time tᵣ₁. UE 120-1 thereafter transmits a communication signal 415-1 to RU 140 that indicates receipt, at time tᵣ₁, of the reflection of the sensing signal originally transmitted at to, and possibly includes Global Positioning System (GPS) coordinates of UE 120-1. A second reflection 410-2 of the sensing signal, originally transmitted at time t₀ and reflected off of object 400, reaches a location of UE 120-2 and is received at a time tᵣ₂. UE 120-2 thereafter transmits a communication signal 415-2 to RU 140 that indicates receipt at time tᵣ₂ of the reflection of the sensing signal originally transmitted at to, and possibly includes GPS coordinates of UE 120-2. A third reflection 410-3 of the sensing signal, originally transmitted at time t₀ and reflected off of object 400, reaches a location of RU 130 and is received at a time tᵣ₃. RU 130 notes the time of receipt tᵣ₃ of the reflection 410-3 of the sensing signal 405 that RU 130 transmitted at time to.

In response to the received communication signals 415, RU 140 may use various techniques (e.g., TDoA), the timestamp of the sensing signal, the timestamps of the reflected/scattered signals reflected from, or scattered by, object 400, the UE GPS coordinates, and the known GPS coordinates of RU 130 to determine a position of object 400. RU 140 may employ ISAC to determine various other parameters regarding object 400, including its shape, size, orientation, speed, distance relative to another object(s), or motion relative to another object(s).

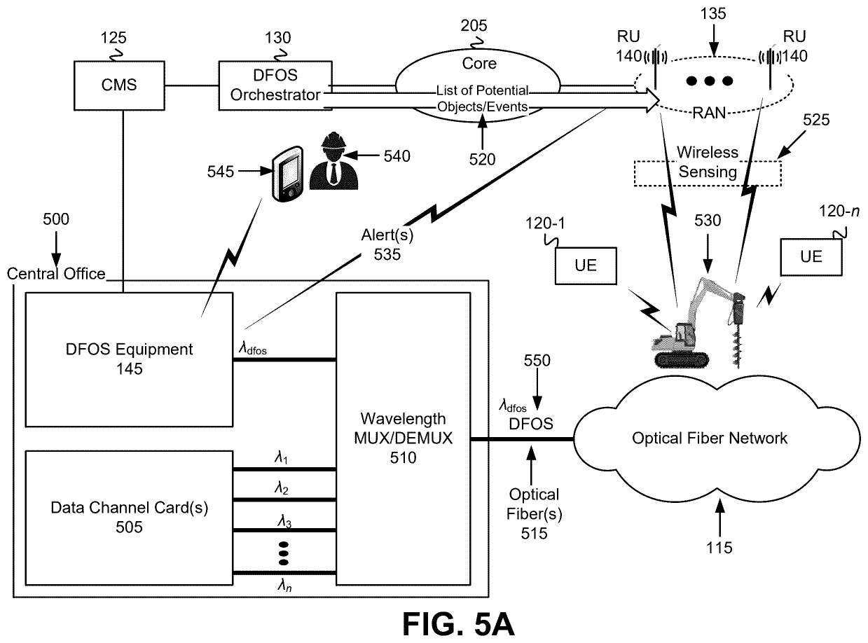

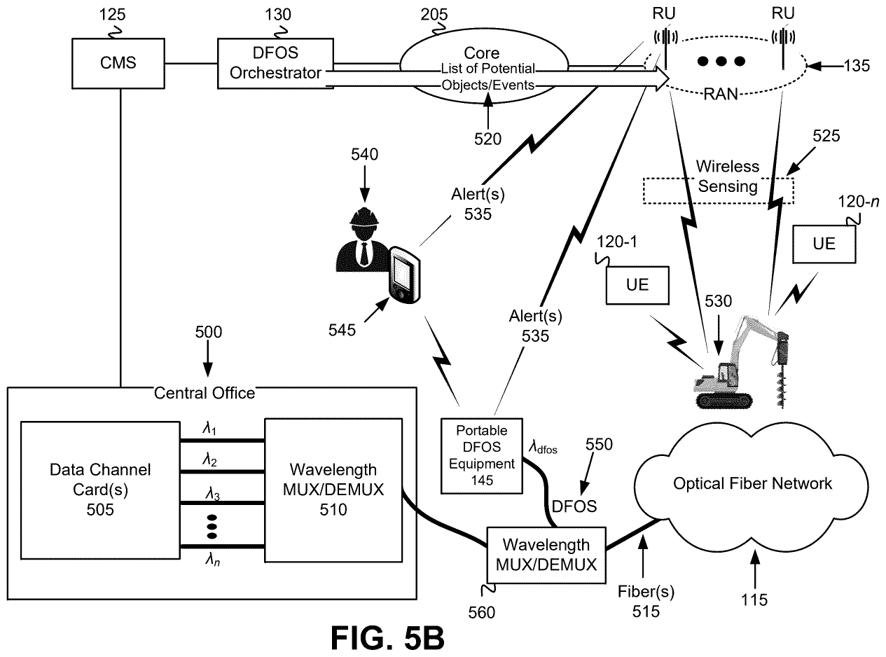

FIGS. 5A and 5B illustrate an overview of the coordination of wireless sensing involving RAN 135, and DFOS involving optical fiber network 115, to perform, for example, risk assessments related to potential objects or events that threaten, or otherwise impact, the safety, security, or physical condition or integrity of optical fiber network 115. FIG. 5A depicts a first implementation in which DFOS equipment 145 is a component that is integrated into existing equipment within optical fiber network 115, such as, for example, within a CO 500 of optical fiber network 115. FIG. 5B depicts a second implementation in which DFOS equipment 145 is a portable, stand-alone device that may be transported to different locations and manually interconnected with optical fiber network 115 (e.g., externally connected between CO 500 and optical fiber network 115 with a fiber optic link) by a field technician or field engineer.

In the implementation shown in FIG. 5A, DFOS equipment 145 may be installed as a device within a CO 500 that is a component of optical fiber network 115. CO 500 may additionally include one or more data channel cards 505, and a wavelength multiplexer/demultiplexer (MUX/DEMUX) 510. Wavelength MUX/DEMUX 510 may selectively multiplex optical signals at n wavelengths (i.e., λ₁, λ₂, . . . , λₙ) transmitted by data channel card(s) 505 in addition to optical signals transmitted from DFOS equipment 145 over at least one particular DFOS wavelength λ_{DFOS}. Wavelength MUX/DEMUX 510 routes the multiplexed optical signals out an optical fiber 515 into optical fiber network 115. The optical signals sent from DFOS equipment 145 at wavelength(s) λ_{DFOS} may be used for DFOS within the optical fibers of optical fiber network 115.

The coordination of wireless sensing involving RAN 135, and DFOS involving optical fiber network 115, may be initiated, as shown in FIG. 5A, with RUs 140 of RAN 135 each receiving a list 520 of potential objects/events from DFOS orchestrator 130 via core network 205. The RUs 140 then, in cooperation with UE s 120-1 through 120-n, engage in wireless sensing 525 to detect one or more potential objects/events contained in the list 520. In the example of FIG. 5A, the RUs 140 of RAN 135, using wireless sensing 525, detect construction equipment 530 (e.g., a digging machine) that is located within a vicinity of certain underground components of optical fiber network 115, such as underground optical fibers. Each RU 140 that potentially detects the construction equipment 530 sends an alert 535, via a wireless signal, to DFOS equipment 145. Alternatively, the RU(s) 140 may send the alert 535 via a wired signal, such as via the Internet (not shown). Additionally, though not shown, the RU(s) 140 may send the alert 535 via wireless signals to a field technician/engineer 540 at the technician's/engineer's smart phone, laptop, or tablet device 545, which, in turn, may forward the alert-related information to DFOS equipment 145. The field technician/engineer 540 may also manually initiate the performance of DFOS by DFOS equipment 145 responsive to receipt of the alert 535.

Based on the alert(s) 535 from RU(s) 140, DFOS equipment 145, either automatically or manually based on commands from the field technician/engineer 540, may perform distributed fiber optic sensing 550 to acquire strain, temperature, and/or vibration data based on Brillouin, Raman, or Rayleigh scattering occurring in the optical fibers of the fiber optic network 115. In one implementation, DFOS equipment 145 accumulates the strain, temperature, and/or vibration data, in addition to the potential objects/events contained in the alert(s) 535 received from the RU(s) 140 of RAN 135 and analyzes the cumulative data to perform a risk assessment related to optical fiber network 115, as described further below.

In the implementation shown in FIG. 5B, DFOS equipment 145 includes a portable, stand-alone device that may be transported to different locations within optical fiber network 115 and then manually interconnected with optical fiber network 115 by, for example, a field technician/engineer 540. In the example of FIG. 5B, the field technician/engineer 540 has externally interconnected DFOS equipment 145 into one input of a wavelength MUX/DEMUX 560, with the output of CO 500 being input into another input of MUX/DEMUX 560. The output of MUX/DEMUX 560 may then be input into an optical fiber 515 (e.g., an outside plant cable) of optical fiber network 115. In this implementation, in which DFOS equipment is a portable, stand-alone device, CO 500 includes one or more data channel cards 505, and a wavelength multiplexer/demultiplexer (MUX/DEMUX) 510 that, in normal use, connects to the input/output optical fiber(s) 515 of the optical fiber network 115. In normal operation, prior to insertion of DFOS equipment 145 and wavelength MUX/DEMUX 560 between CO 500 and optical fiber 515, wavelength MUX/DEMUX 510 selectively multiplexes optical signals at n wavelengths (i.e., λ₁, λ₂, . . . , λₙ) transmitted by data channel card(s) 505 and routes the multiplexed optical signals out the optical fiber(s) 515 into optical fiber network 115. Wavelength MUX/DEMUX 510 may also demultiplex the n wavelengths (i.e., λ₁, λ₂, . . . , λₙ) received over optical fiber(s) 515 and route optical signals on each of the demultiplexed wavelengths via a respective output to data channel card(s) 505.

The portable DFOS equipment 145, when interconnected with wavelength MUX/DEMUX 560, may transmit optical signals at one or more particular wavelengths λ_{DFOS} for use in implementing DFOS within optical fiber network 115. The coordination of wireless sensing involving RAN 135, and DFOS involving optical fiber network 115, may be initiated as previously described with respect to FIG. 5A above. After one or more RUs 140 engage in wireless sensing 525 and detect a potential construction equipment 530 (or other object or event) that is located within a vicinity of certain underground components of optical fiber network 115, each detecting RU(s) 140 sends an alert 535, via a wireless signal, to portable DFOS equipment 145, and also may send the alert 535 via a wireless signal to the field technician's/engineer's smart phone, laptop, or tablet device 545.

As also previously described, DFOS equipment 145, subsequent to receipt of alert(s) 535 from RU(s) 140, either automatically or manually (in accordance with commands from the field technician/engineer 540), may perform distributed fiber optic sensing 550 to acquire strain, temperature, and/or vibration data based on Brillouin, Raman, and/or Rayleigh scattering in the optical fibers of the fiber optic network 115. In one implementation, DFOS equipment 145 accumulates the strain, temperature, and/or vibration data, in addition to the potential objects/events contained in the alert(s) 535 received from the RU(s) 140 of RAN 135 and analyzes the cumulative data to perform a risk assessment related to optical fiber network 115, as described further below. After conducting the DFOS sensing 550, field technician/engineer 540 may relocate the portable DFOS equipment to perform DFOS sensing over a different portion of optical fiber network 115, or over a different optical fiber network 115 entirely.

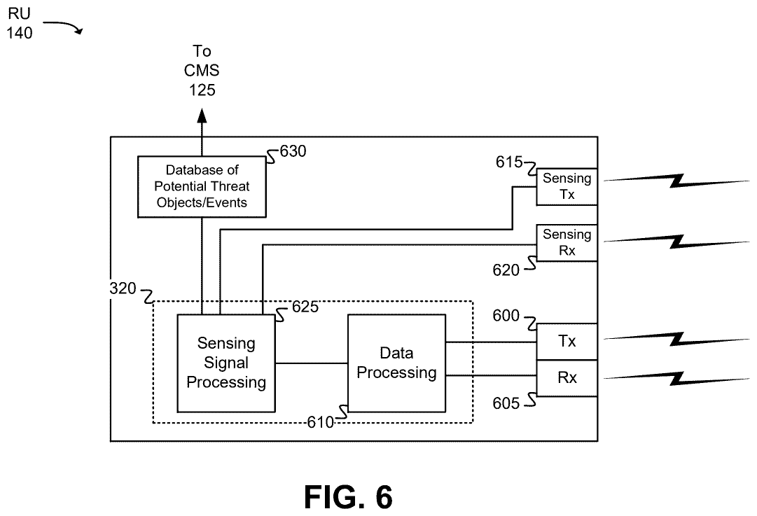

FIG. 6 depicts an example of components of an RU 140 of a RAN 135 of mobile network 110 that may be used in performing wireless sensing, as described herein. As shown, RU 140 may include a transmitter (Tx) 600, a receiver (Rx) 605, a data processing function 610, a sensing Tx 615, a sensing Rx 620, a sensing signal processing function 625, and a database 630 of potential threat objects/events.

Tx 600 includes a wireless (e.g., RF) transmitter that generates a wireless signal for transmission via an antenna (not shown). The antenna may include any type of antenna employed in mobile networks, such as, for example, an array antenna. Tx 600 may transmit wireless signals for reception by UEs 120, by other devices, or by other components of mobile network 110.

Rx 605 includes a wireless (e.g., RF) receiver that receives wireless signals from UEs 120, or from other devices or components of mobile network 110. Rx 605 may also receive, from UEs 120 located in the vicinity of optical fiber network 115, data related to reflection and/or backscattering of the wireless sensing signals transmitted by Sensing Tx 615. Rx 605 may share the antenna used by Tx 600, or may have its own dedicated antenna. Data processing function 610 may process data that may be encoded and transmitted as wireless signals by Tx 600, or data decoded from wireless signals received by Rx 605.

Sensing Tx 615 may, in one implementation, include a dedicated wireless transmitter that transmits wireless sensing signals for implementing, for example, ISAC. Sensing Rx 620 may, in one implementation, include a dedicated wireless receiver that receives reflections or scattering of wireless signals for implementing, for example, ISAC. In another implementation, sensing Tx 615 may be integrated into Tx 600 and may transmit both of wireless sensing signals, and data signals, to UEs 120, and sensing Rx 620 may be integrated into Rx 605 and may receive both of signals related to wireless sensing and data signals from UEs 120. Sensing signal processing function 625 receives and processes decoded data, received by sensing Rx 620, and may process the data that may correspond to reflections and/or scattering of wireless sensing signals transmitted by sensing Tx 615. Database 630 of potential threat objects/events stores data that identifies various different types of objects and/or events that may potentially threaten the successful operation of optical fiber network 115. Function 625 may process the wireless sensing data and compare results of the processing with data, stored in database 630, related to potential threat objects or events. Function 625 may detect, for example, construction equipment (e.g., digging machines), aerial vehicles (e.g., Unmanned Aerial Vehicles (UAVs)), traffic accidents, or natural events or disasters. Data processing function 610 and sensing signal processing function 625 may be implemented by, for example, a processing unit 320 of RU 140. Though not shown in FIG. 6, RU 140 may include a wired transceiver for transmitting alerts, or other data, to CMS 125, and for receiving a list of potential threat objects/events from DFOS orchestrator 130 or CMS 125, and may additionally include control and/or analysis functions that operate in conjunction with functions 610, 625 and database 630 to analyze wireless sensing data.

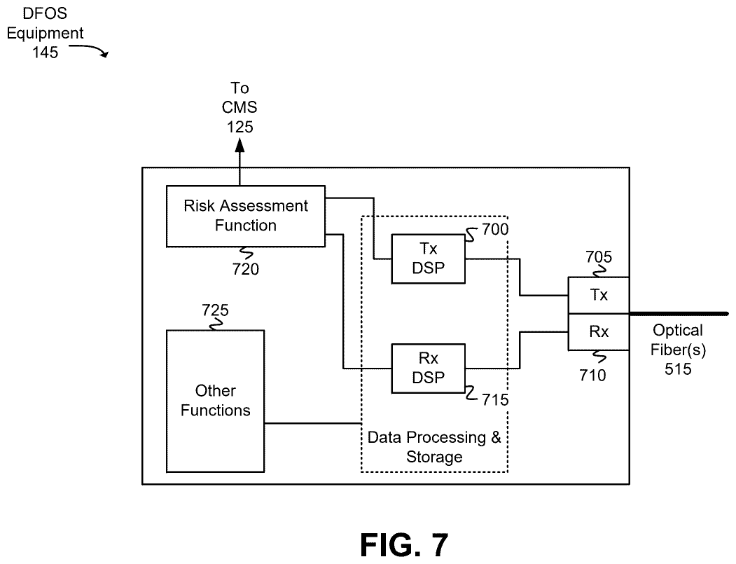

FIG. 7 depicts an example of components of DFOS equipment 145. The DFOS equipment 145 illustrated in FIG. 7 may be a device or system that is an integral component of a CO 500 (or other device, system, or component of optical fiber network 115), as shown and described with respect to FIG. 5A, or may be a portable, stand-alone device as shown and described with respect to FIG. 5B. As shown, DFOS equipment 145 may include a Tx Digital Signal Processing (DSP) function 700, an optical Tx 705, an optical Rx 710, a Rx DSP function 715, a risk assessment function 720, and other functions 725.

Tx DSP function 700 may interact with risk assessment function 720 to determine when to transmit optical signals associated with DFOS, and then cause Tx 705 to transmit corresponding DFOS optical signals. Optical Tx 705 transmits the DFOS optical signals via optical fiber(s) 515 into optical fiber network 115 (not shown).

Optical Rx 710 includes a multi-band optical receiver that receives and converts optical signals, that have traversed at least a portion of optical fiber network 115, into digital data. The received optical signals may include those resulting from the Brillion, Raman and/or Rayleigh scattering of the DFOS optical signals sent into optical fiber network 115 by Tx 705. In one implementation, optical Rx 710 may include a dual-band optical receiver to detect different types of backscattering signals. Rx DSP function 715 processes the output of RX 710, including detecting the scattering of the DFOS optical signals and using those scattered signals to determine strain, temperatures, and/or vibrations associated with the optical fiber network 115 over which the DFOS optical signals traversed. The resulting acquired strain, temperature, and/or vibration data associated with the optical fiber network 115 may be analyzed by risk assessment function 720, in conjunction with the alert(s) received from a RU 140 of a detected potential object/event. Other functions 725 may include additional functions performed by DFOS equipment 145 in support of performing DFOS, or additional components. Other functions 725 may include, for example, a wireless and/or wired transceiver for communicating with CMS 125 and RU 140, and a data storage function for storing an optical fiber route map of optical fiber network 115, a risk assessment table, or other data.

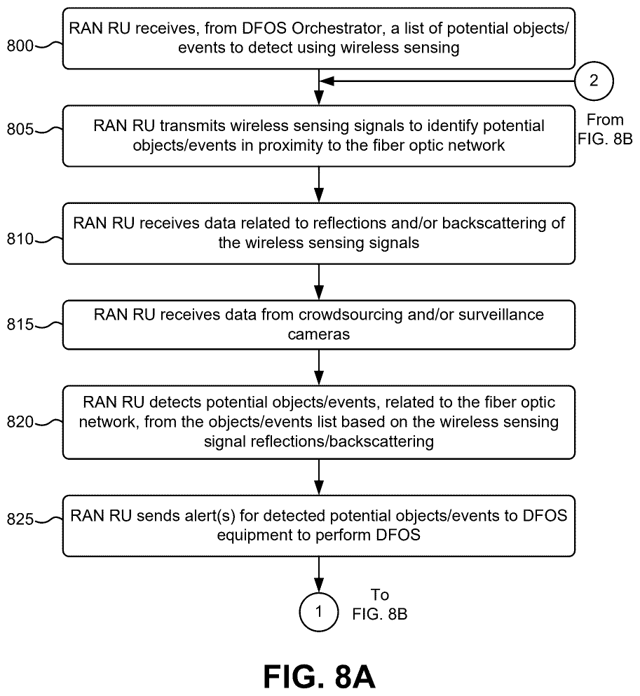

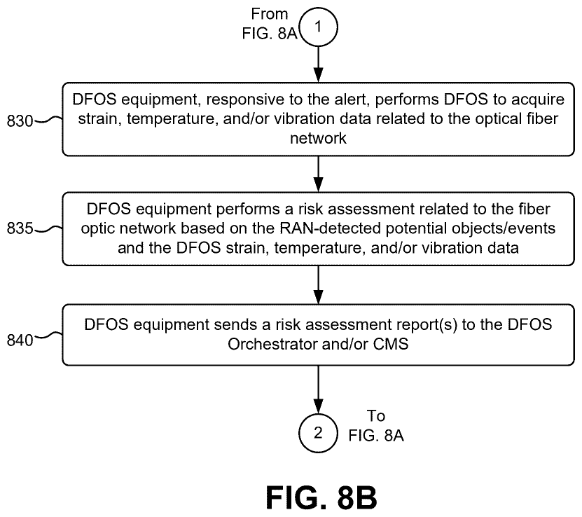

FIGS. 8A and 8B are flow diagrams of an example process for coordinating wireless sensing performed by RAN 135 of mobile network 110, and DFOS sensing performed by DFOS equipment 145, to assess risks related to an optical fiber network 115. The example process of FIGS. 8A and 8B may be implemented by DFOS equipment 145 in cooperation with at least one RU 140 of RAN 135 of mobile network 110. The process of FIGS. 8A and 8B is described with additional reference to the diagrams of FIGS. 5A and 5B.

The example process includes a RAN RU 140 receiving, from DFOS Orchestrator 130, a list of potential objects and/or events to detect using wireless sensing (block 800). The list may detail various different potential objects and/or events that may threaten, or otherwise impact, optical fiber network 115. The list may include, for example, detectable features associated with: 1) digging machines, or other construction equipment, that may dig in the vicinity of buried, underground optical fibers of the optical fiber network 115, 2) aerial vehicles that fly in the vicinity of aerial optical fibers of the optical fiber network 115, 3) traffic accidents in the vicinity of portions of the optical fiber network 115, or 4) natural disasters or events (e.g., earthquakes, forest fires, tornadoes, tree falling down) that may threaten or impact components of, or a portion of, the optical fiber network 115. FIGS. 5A and 5B depict DFOS orchestrator 130 sending a list 520 of potential objects/events to one or more RUs 140 of RAN 135 across core network 205 of mobile network 110.

RAN RU 140 transmits wireless sensing signals to identify potential objects/events in proximity to the fiber optic network 115 (block 805) and receives data related to reflections and/or backscattering of the wireless sensing signals (block 810). RAN RU 140 may, for example, implement ISAC to transmit RF sensing signals directed at various different areas in a vicinity of the RU 140. RU 140 may use various different types of antennas, or different antenna beam forming/directing techniques, to direct wireless sensing signals at desired areas in the vicinity of the RU 140. Referring to FIGS. 5A and 5B, these figures depict examples of RUs 140 transmitting wireless sensing signals 525 to detect construction equipment 530 within proximity to buried optical fibers of optical fiber network 115. As previously described with respect to FIG. 4, RU 140 may receive communications, from UEs 120 that are located in proximity to a particular object or event, where the communications include data related to the reflections of, or scattering of, the wireless sensing signals off of, or by, the object or event.

RAN RU 140 receives data from crowdsourcing and/or surveillance cameras (block 815). RU 140 may itself directly receive the crowdsourcing data or surveillance camera data, or at least one other node, device, or system in mobile network 110 or data network 105 may analyze crowdsourcing data, and/or the images/video of surveillance camera data, to detect particular objects or an occurrence of particular events and may provide notifications of such objects or events to RU 140 via mobile network 110 and/or data network 105. The crowdsourcing data and/or the surveillance camera data may be used to validate, or corroborate, particular objects or events detected using wireless sensing by RU 140. In some implementations, block 815 may be omitted from the process of FIGS. 8A and 8B.

RAN RU 140 detects potential objects/events, related to the fiber optic network 115, from the objects/events list based on the wireless sensing signal reflections/backscattering (block 820). RU 140 may additionally use the crowdsourcing data and/or the surveillance camera data of block 815 in the detection of potential objects and/or events related to threats or impacts to the optical fiber network 115. RU 140 analyzes data resulting from the wireless sensing signal reflections and/or backscattering and compares the data with the detectable features, contained in the objects/events list previously received from DFOS orchestrator 130 in block 800, to detect the existence of certain objects within a vicinity of optical fiber network 115 or the occurrence of certain events within proximity to the optical fiber network 115.

RAN RU 140 sends an alert(s) for detected potential objects/events to DFOS equipment 145 to perform DFOS (block 825). Additionally, or alternatively, RU 140 may send the alert(s) for detected potential objects/events to DFOS orchestrator 130, CMS 125, and/or to a device associated with a field technician or field engineer or a device associated with a construction team (e.g., a team digging near underground optical fibers). DFOS orchestrator 130 or CMS 125, upon receipt of the alert, may, if the alert has not been sent directly from RU 140 to the DFOS equipment 145, forward the alert on to DFOS equipment 145 (e.g., via data network 105 or mobile network 110). Additionally, or alternatively, RU 140 may send an alert to the portable DFOS equipment 145, or to the smart phone, laptop, or tablet device 545 carried by the field technician/engineer 540, to instruct the field technician/engineer 540 to move the portable DFOS equipment 145 to another particular location (e.g., near a different CO 500) to perform DFOS at the new location.

DFOS equipment 145, responsive to the alert from RU 140, performs DFOS to acquire strain, temperature, and/or vibration data related to the fiber optic network 115 (block 830-FIG. 8B). DFOS equipment 145 transmits optical signals into optical fiber network 115 and uses existing DFOS techniques obtains strain, temperature, and/or vibration data that results from Brillouin, Raman and/or Rayleigh backscattering that may occur within the optical fibers of optical fiber network 115. In some implementations, DFOS equipment 145, or RU 140, may send the strain, temperature, and/or vibration data to data network 105 for storage (e.g., stored in the “cloud”) and future retrieval by DFOS equipment 145 or by other devices or systems. FIGS. 5A and 5B show DFOS equipment 145 performing DFOS 550 upon optical fiber network 115.

DFOS equipment 145 performs a risk assessment related to the fiber optic network 115 based on the RAN-detected potential objects/events and the DFOS strain, temperature and/or vibration data (block 835) and sends a risk assessment report(s) to DFOS Orchestrator 130 and/or CMS 125 (block 840). Risk assessment function 720 of DFOS equipment 145 may perform the risk assessment using Artificial Intelligence (AI)/Machine Learning (ML) algorithms that use stored, historical object/event data and DFOS data as training data to generate updated risk assessment models that can be used to determine risk levels that apply to future threats to, or impacts upon, the optical fiber network 115. The updated risk assessment models are used by DFOS equipment 145 to assess and identify possible threats or impacts to optical fiber network 115 based on particular RAN-detected objects/events and/or particular levels of strain, temperature and/or vibration indicated by DFOS. In other implementations, DFOS equipment may provide the DFOS strain, temperature and/or vibration data to RU 140 and RU 140 may instead perform the risk assessment related to threat objects or events. In this implementation, RU 140 further provides risk assessment reports to DFOS orchestrator 130 and/or CMS 125.

DFOS orchestrator 130 may, based on risk assessment reports received from DFOS equipment 145, update the list of potential objects/events to be sent to one or more RUs 140 in RAN 135 of mobile network 110. CMS 125 may further perform various actions based on risk assessment reports received from DFOS equipment 145, such as, for example, initiating the re-routing traffic over different optical fibers of optical fiber network 115 to route the traffic around particular objects or events that have potentially been detected at or near certain components, or certain areas, of the optical fiber network 115. CMS 125 may also initiate testing of components of optical fiber network 115 to identify potential failures and/or may generate a report to a field technician/engineer to request the performance of on-site testing of particular components of the optical fiber network 115 that may have been negatively impacted by the detected objects or events.

Subsequent to block 840, the process of FIGS. 8A and 8B may return to block 805 (FIG. 8A) to continue RU wireless sensing based on the list of potential objects/events previously received from DFOS orchestrator 130. The process of FIGS. 8A and 8B may also repeat, starting instead at block 800, when DFOS orchestrator 130 sends, and RU 140 receives, an updated list of potential objects/events.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 8A and 8B, and sequences of operations, messages, and/or data flows with respect to FIGS. 5A and 5B, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 320) of a device. A non-transitory storage medium includes one or more of the storage mediums described in relation to memory 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
obtaining an indication of at least one object or event detected in a vicinity of a fiber optic network by a Radio Access Network (RAN) of a mobile network using wireless sensing;
acquiring, by the device based on the RAN-detected at least one object or event, one or more of strain, temperature, or vibration data related to the fiber optic network;
performing, by the device, a risk assessment related to the fiber optic network based on the RAN-detected at least one object or event and the acquired one or more of strain, temperature, or vibration data; and
communicating results of the risk assessment to at least one of an optical fiber network management system, a field technician, or a field engineer.

2. The method of claim 1, wherein the wireless sensing comprises Integrated Sensing and Communication (ISAC) and wherein acquiring the one or more of the strain, temperature, or vibration data comprises:
performing, by the device, distributed fiber optic sensing (DFOS).

3. The method of claim 1, wherein obtaining the indication of at least one object or event detected in the vicinity of the fiber optic network comprises:
detecting, by at least one Radio Unit (RU) of the RAN, the at least one object or event in the vicinity of the fiber optic network using the wireless sensing.

4. The method of claim 1, wherein the risk assessment relates to potential damage to the fiber optic network caused by the detected at least one object or event.

5. The method of claim 1, wherein the at least one object or event comprises one or more of construction equipment in the vicinity of the fiber optic network, an object flying in the air in the vicinity of the fiber optic network, a traffic accident occurring in the vicinity of the fiber optic network, or a natural incident or disaster occurring in the vicinity of the fiber optic network.

6. The method of claim 5, wherein the object flying in the air comprises an aerial vehicle (AV) flying near aerial fibers of the fiber optic network.

7. The method of claim 2, wherein the DFOS is based on at least one of Brillouin, Raman, or Rayleigh scattering occurring in the fiber optic network.

8. The method of claim 1, wherein the device comprises one of distributed fiber optic sensing (DFOS) equipment associated with the fiber optic network or a Radio Unit (RU) of the RAN.

9. A device, comprising:
at least one communication interface configured to communicate via at least one of wired or wireless mechanisms; and
at least one processor configured to:
obtain an indication of at least one object or event detected in a vicinity of a fiber optic network by a Radio Access Network (RAN) of a mobile network using wireless sensing,
acquire, based on the RAN-detected at least one object or event, one or more of strain, temperature, or vibration data related to the fiber optic network,
perform a risk assessment related to the fiber optic network based on the RAN-detected at least one object or event and the acquired one or more of strain, temperature, or vibration data, and
communicate, via the at least one communication interface, results of the risk assessment to at least one of an optical fiber network management system, a field technician, or a field engineer.

10. The device of claim 9, wherein the wireless sensing comprises Integrated Sensing and Communication (ISAC) and wherein the at least one processor is further configured to:
initiate performance of distributed fiber optic sensing (DFOS).

11. The device of claim 9, wherein the device comprises a Radio Unit (RU) of the RAN and wherein, when obtaining the indication of the at least one object or event in the vicinity of the fiber optic network, the at least one processor is further configured to:
detect the at least one object or event in the vicinity of the fiber optic network using the wireless sensing.

12. The device of claim 9, wherein the risk assessment relates to potential damage to the fiber optic network caused by the detected at least one object or event.

13. The device of claim 9, wherein the at least one object or event comprises one or more of construction equipment in the vicinity of the fiber optic network, an object flying in the air in the vicinity of the fiber optic network, a traffic accident occurring in the vicinity of the fiber optic network, or a natural incident or disaster occurring in the vicinity of the fiber optic network.

14. The device of claim 13, wherein the object flying in the air comprises an aerial vehicle (AV) flying near aerial fibers of the fiber optic network.

15. The device of claim 10, wherein the DFOS is based on at least one of Brillouin, Raman, or Rayleigh scattering occurring in the fiber optic network.

16. The device of claim 9, wherein the device comprises one of distributed fiber optic sensing (DFOS) equipment associated with the fiber optic network or a Radio Unit (RU) of the RAN.

17. A non-transitory storage medium storing instructions executable by a device, wherein execution of the instructions causes the device to:
obtain an indication of at least one object or event detected in a vicinity of a fiber optic network by a Radio Access Network (RAN) of a mobile network using wireless sensing;
acquire, based on the RAN-detected at least one object or event, one or more of strain, temperature, or vibration data related to the fiber optic network,
perform a risk assessment related to the fiber optic network based on the RAN-detected at least one object or event and the acquired one or more of strain, temperature, or vibration data; and
communicate results of the risk assessment to at least one of an optical fiber network management system, a field technician, or a field engineer.

18. The non-transitory storage medium of claim 17, wherein the wireless sensing comprises Integrated Sensing and Communication (ISAC), wherein the objects or events detected in the vicinity of the fiber optic network by the RAN are detected by at least one Radio Unit (RU) of the RAN, and wherein, when acquiring the one or more of the strain, temperature, or vibration data, execution of the instructions further causes the device to:
perform distributed fiber optic sensing (DFOS).

19. The non-transitory storage medium of claim 17, wherein the risk assessment relates to potential damage to the fiber optic network caused by the detected at least one object or event, and wherein the at least one object or event comprises one or more of construction equipment in the vicinity of the fiber optic network, an object flying in the air in the vicinity of the fiber optic network, a traffic accident occurring in the vicinity of the fiber optic network, or a natural incident or disaster occurring in the vicinity of the fiber optic network.

20. The non-transitory storage medium of claim 17, wherein the device comprises one of distributed fiber optic sensing (DFOS) equipment associated with the fiber optic network or a Radio Unit (RU) of the RAN.
